(19) United States
(12) Patent Application Publication
(10) Pub. No.: US 2023/0186177 A1
(43) Pub. Date: Jun. 15, 2023

(54) TECHNOLOGIES FOR ENABLING EFFICIENT CHECK IN OPERATIONS FOR HOTELS

(71) Applicant: Astics Inc., San Mateo, CA (US)

(72) Inventors: Mrunal Desai, Santa Clara, CA (US); Ratan Hodar, San Francisco, CA (US); Chintak Desai, San Francisco, CA (US); Yogesh Thakkar, Sugar Land, TX (US)

(21) Appl. No.: 17/946,155

(22) Filed: Sep. 16, 2022

Related U.S. Application Data
(60) Provisional application No. 63/247,421, filed on Sep. 23, 2021.

(51) Int. Cl. G06Q 10/02; G06Q 50/12; G06Q 20/40; G07C 9/25

(52) U.S. Cl. CPC G06Q 10/02; G06Q 50/12; G06Q 20/40145; G07C 9/253

(57) ABSTRACT

Technologies for enabling efficient check in operations for hotels include a compute device. The compute device includes circuitry configured to receive a request to check in a guest at a hotel without a human front desk operator present at the hotel. The circuitry is further configured to verify an identity of the guest, obtain payment, from the guest, for reservation of a room of the hotel and provide, to the guest and in response to obtaining payment for reservation of the room, a key to the room of the hotel.

### CROSS-REFERENCE TO RELATED APPLICATION

This application claims the benefit, under 35 U.S.C. § 119(e), of U.S. Provisional Patent Application No. 63/247,421, filed Sep. 23, 2021, the entirety of which is hereby expressly incorporated by reference herein.

### BACKGROUND

Organizations that operate hotels typically employ one or more human front desk operators to greet guests, explain rates, terms, and conditions to the guests, take payment from the guests to reserve one or more rooms of the hotel, provide the guests with key(s) to room(s) and/or otherwise register guests upon their arrival at the hotel (i.e., a “check in” operation). The use of front desk operators to perform the above tasks represents a cost to the organization that may often result in less than optimal returns. For example, a human front desk operator may occupy the front desk during a time period in which no guests enter the hotel to reserve a room (e.g., early hours of the morning). Further, last minute scheduling conflicts may render a human front desk operator unable to attend his or her shift and leave the organization in a state in which nobody is available to perform the tasks at the front desk of the hotel. Additionally, the reliance on in-person communication for front desk operations may pose liabilities to personnel physically present at the front desk, such as from communicable illnesses that may be spread from a guest to the front desk operator. Protecting against transmission of such illnesses may involve additional costs for the organization, such as the purchase of transparent barriers to separate front desk operators from guests, face masks, and sterilization resources. In short, funds that could be used by an organization to improve the hotel itself are instead lost due to the costs and inefficiencies of manning front desks with people.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for enabling efficient check in operations for hotels;

FIG. 2 is a simplified block diagram of at least one embodiment of a compute device of the system of FIG. 1; and

FIGS. 3-7 are simplified block diagrams of at least one embodiment of a method for performing an efficient check in operation for a hotel that may be performed by the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

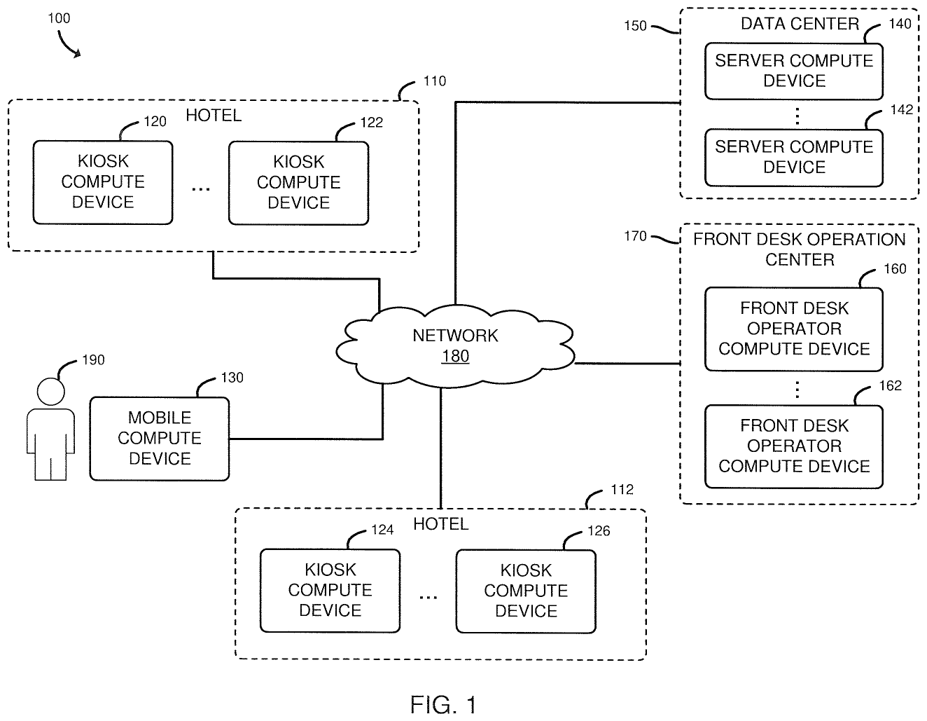

Referring now to FIG. 1, a system 100 for enabling efficient check in operations includes, in the illustrative embodiment, multiple hotels 110, 112, each with a corresponding set of kiosk compute devices 120, 122, 124, 126. While two hotels 110, 112 are shown in the system 100, it should be understood that in other embodiments, the number of hotels may differ. Further, while two kiosk compute devices are shown in each hotel, it should be understood that in other embodiments, the number of kiosk compute devices present in the hotels may be different. Additionally, the system 100 may include a mobile compute device 130 (e.g., a smart phone, a tablet, a notebook compute device, a wearable compute device, etc.) operated by a user 190 (e.g., a guest). Further, in the illustrative embodiment, the system 100 includes a set of server compute devices 140, 142 in a data center 150 as well as a set of front desk operator compute devices 160, 162 in a front desk operation center 170 (e.g., an office building). In some embodiments, the server compute devices 140, 142 may be co-located (e.g., in the same building) with the front desk operator compute devices 160, 162 and/or integrated with the front desk operator compute devices 160, 162. While two server compute devices 140, 142 and two front desk operator compute devices 160, 162 are shown, it should be understood that the number of server compute devices and front desk operator compute devices may differ in other embodiments.

In operation, and as explained in more detail herein, the system 100 performs a check in process (e.g., operation) with the user (e.g., guest) 190 without the involvement of an on-site human front desk operator (at the corresponding hotel). Rather, a compute device (e.g., a kiosk compute device 120, 122, 124, 126 or the mobile compute device 130) of the system 100 communicates with backend compute devices (e.g., one or more of the server compute devices 140, 142 and/or front desk operator compute devices 160, 162) to conduct a check in process, either through a communication session with a remote (i.e., not at the hotel) front desk operator (e.g., physically present at a front desk operator compute device 160, 162) or with an artificial intelligence based front desk operator (e.g., executed by a server compute device 140, 142, and/or a front desk operator compute device 160, 162). In doing so, and as described in more detail herein, the system 100 verifies the identity of the guest, presents registration data indicative of the rates, terms, and conditions for reserving room(s) of the hotel, processes payment made by the guest for reservation of one or more rooms of the hotel, and provides one or more keys to the reserved room(s) to the guest. As such, compared to typical hotels in which one or more front desk operators are required to be on location (e.g., at the hotel) to perform the check in operation, the system 100 enables a significantly more efficient check in operation, eliminating the costs and liabilities typically associated with keeping a front desk position physically occupied at the hotel (e.g., paying a front desk operator to be present even when guests are not arriving frequently, risking not having a front desk operator available on location due to scheduling conflicts or insufficient personnel to be physically present at every hotel owned by an organization, and protecting the front desk operators from communicable illnesses from guests, etc.).

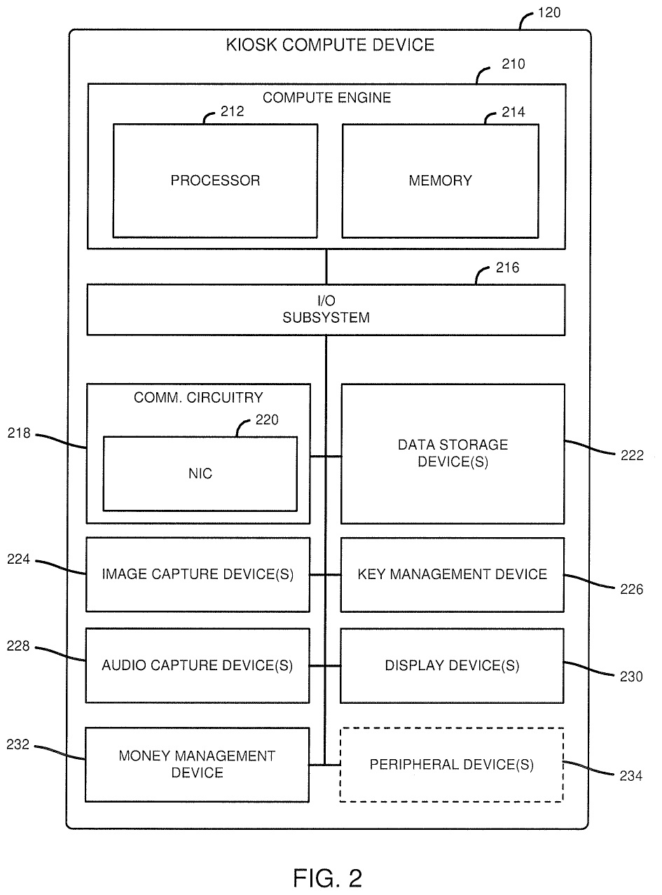

Referring now to FIG. 2, the illustrative kiosk compute device 120 includes a compute engine 210, an input/output (I/O) subsystem 216, communication circuitry 218, a data storage subsystem 222, one or more image capture devices 224, a key management device 226, one or more audio capture devices 228, one or more display devices 230, and a money management device 232. Of course, in other embodiments, the kiosk compute device 120 may include other or additional components, such as peripheral components (e.g., a mouse, a physical keyboard, etc.). Additionally, in some embodiments, one or more of the illustrative components may be incorporated in, or otherwise form a portion of, another component.

The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as registration data indicative of rates, terms, and conditions associated with the reservation of one or more rooms of a hotel, identification data submitted by a guest, payment information submitted by a guest, communication session data (e.g., audio and/or video data representing a communication between the guest and a remote front desk operator), applications, libraries, and drivers.

The compute engine 210 is communicatively coupled to other components of the kiosk compute device 120 via the I/O subsystem 216, which may be embodied as circuitry and/or components to facilitate input/output operations with the compute engine 210 (e.g., with the processor 212 and the main memory 214) and other components of the kiosk compute device 120. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the kiosk compute device 120, into the compute engine 210.

The communication circuitry 218 may be embodied as any communication circuit, device, or collection thereof, capable of enabling communications over a network between the kiosk compute device 120 and another device (e.g., a server compute device 140, 142, a front desk operator compute device 160, 162, a mobile compute device 130, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the kiosk compute device 120 to connect with another compute device (e.g., a server compute device 140, 142, a front desk operator compute device 160, 162, a mobile compute device 130, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. In such embodiments, the local processor of the NIC 220 may be capable of performing one or more of the functions of the compute engine 210 described herein. Additionally or alternatively, in such embodiments, the local memory of the NIC 220 may be integrated into one or more components of the kiosk compute device 120 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each image capture device 224 may be embodied as any type of device (e.g., a digital camera) configured to obtain visual information from the environment to be encoded in a digital form (e.g., as pixel values of an image or video) for local processing, storage, and/or transmission to another device (e.g., to a front desk operator compute device 160, 162). The key management device 226 may be embodied as any device (e.g., an electronic device, an electromechanical device, etc.) configured to dispense one or more keys (a metal key adapted to be inserted into a door lock, a key card, a fob, etc.) to enable a guest to access a room (e.g., of a hotel). In doing so, the key management device 226 may be configured to encode an access code (e.g., a unique numeric code) in a key (e.g., on a magnetic strip of a key card, in a microchip of a key card or fob capable of transmitting data via wireless communication such as radio frequency identification (RFID) and/or near field communication (NFC)).

Each audio capture device 228 may be embodied as any device (e.g., a microphone) configured to obtain audio information from the environment and encode the audio information into a digital form for local processing, storage, and/or transmission to another device (e.g., as voice data transmitted to a front desk operator compute device 160, 162). Each display device 230 may be embodied as any device or circuitry (e.g., a liquid crystal display (LCD), a light emitting diode (LED) display, a cathode ray tube (CRT) display, etc.) configured to display visual information (e.g., text, graphics, etc.) to a viewer (e.g., guest). In some embodiments, a display device 230 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from the user (e.g., guest).

The money management device 232 may be embodied as any device or circuitry (e.g., an electronic device, an electromechanical device, etc.) configured to receive physical currency (e.g., dollars, coins, etc.) and/or non-physical currency (e.g., information embodied on a payment card, etc.) and, in some embodiment, provide change (e.g., physical currency) in response to a determination that an overpayment has been received for an amount due (e.g., an overpayment for reservation of a hotel room). In some embodiments, the money management device 232 may be additionally configured to determine whether a payment is fraudulent (e.g., determining whether security features are present in the currency, such as a strip embedded in a dollar bill that is visible when exposed to a light, watermark(s), determining whether payment card data satisfies the Luhn algorithm, etc.). In some embodiments, the money management device may utilize or be incorporated into an image capture device 224 (e.g., to obtain images of surfaces (e.g., the front and back) of a payment card, the communication circuitry (e.g., to obtain payment data transmitted wirelessly from a payment device), and/or the key management device 226 (e.g., to read data encoded on a magnetic strip of a payment card)).

In the illustrative embodiment, the components of the kiosk compute device 120 are housed in a single unit (e.g., a kiosk). The compute devices 122, 124, 126, 130, 140, 142, 160, 162 may have components similar to those described in FIG. 2 with reference to the kiosk compute device 120. The description of those components of the kiosk compute device 120 is equally applicable to the description of components of the compute devices 122, 124, 126, 130, 140, 142, 160, 162. However, it should be noted that in the illustrative embodiment, the mobile compute device 130, the server compute devices 140, 142, and the front desk operator compute devices 160, 162 may not include certain specialize components present in a kiosk compute device 120, 122, 124, 126 such as the key management device 226 or the money management device 232 (e.g., a money management device configured to process physical currency). Further, it should be appreciated that any of the devices 120, 122, 124, 126, 130, 140, 142, 160, 162 may include other components, sub-components, and devices commonly found in a computing device, which are not discussed above in reference to the kiosk compute device 120 and not discussed herein for clarity of the description.

In the illustrative embodiment, the compute devices 120, 122, 124, 126, 130, 140, 142, 160, 162 are in communication via a network 180, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

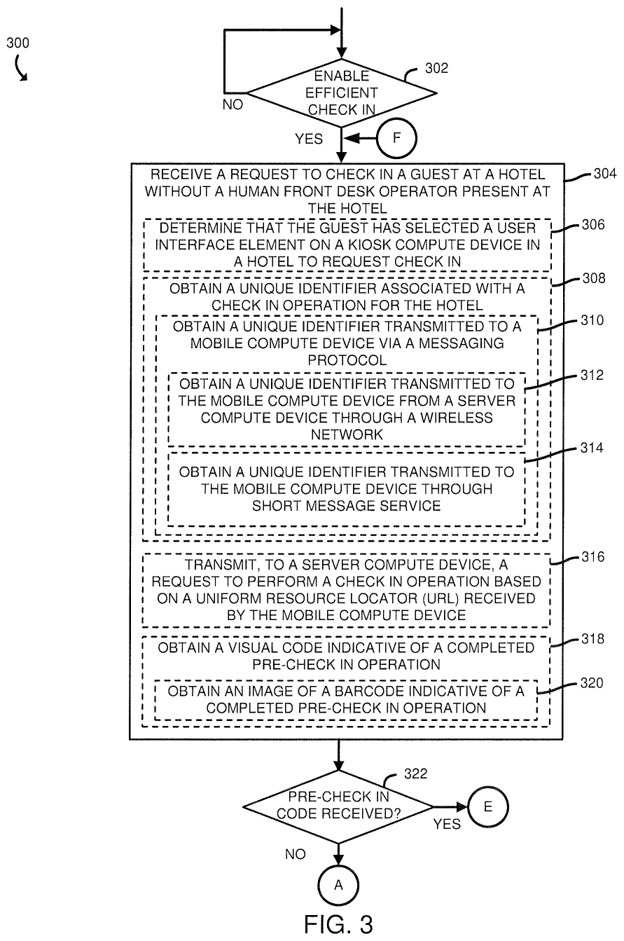

Referring now to FIG. 3, the system 100 (e.g., a kiosk compute device 120, a mobile compute device 130, etc.), in the illustrative embodiment, may perform a method 300 for performing an efficient check in operation. The method 300 may be performed by different compute devices of the system 100. However, for simplicity and clarity, the method 300 is described below as being performed by a kiosk compute device (e.g., the kiosk compute device 120), except for certain operations that would be performed by the mobile compute device 130 (e.g., if the mobile compute device 130 was performing the method 300). The method 300 begins with block 302 in which the kiosk compute device 120 determines whether to enable efficient check in. In doing so, the kiosk compute device 120 may determine whether a configuration setting (e.g., in memory 214 or in storage 222) indicates to enable efficient check in operations, whether network connectivity exists between compute devices of the system 100 (e.g., whether the kiosk compute device 120 is able to send and receive communications with other devices connected to the network 180, such as the server compute devices 140, 142, the front desk operator compute devices 160, 162, etc.), and/or based on other factors. Regardless, in response to a determination to enable efficient check in operations, the method 300 advances to block 304 in which the kiosk compute device 120 may receive a request to check in a guest at a hotel (e.g., the hotel 110) without a human front desk operator present at the hotel (e.g., the hotel 110).

In receiving the request, and as indicated in block 306, the kiosk compute device 120 may determine that the guest has selected a user interface element on the kiosk compute device 120 in the hotel 110 to request check in (e.g., detect that the guest has selected an onscreen “May I Help You?” or “Check In” button displayed by the kiosk compute device 120). In embodiments in which the method 300 is performed by a mobile compute device (e.g., the mobile compute device 130), the mobile compute device 130 may obtain a unique identifier associated with a check in operation for the hotel (e.g., the hotel 110), as indicated in block 310. In doing so, the mobile compute device 130 may obtain a unique identifier transmitted from a server compute device (e.g., the server compute device 140) through a wireless network (e.g., a cellular portion of the network 180), as indicated in block 312. As indicated in block 314, the mobile compute device 130 may obtain a unique identifier that was transmitted to the mobile compute device 130 through a short message service (SMS) (e.g., as a text message sent from the server compute device 140). The unique identifier received by the mobile compute device 130, in the illustrative embodiment, uniquely identifies the check in operation among multiple check in operations that may be performed concurrently by other guests using other mobile compute devices to check in to hotels in the system 100. In some embodiments, the mobile compute device 130 may receive the unique identifier in response to sending a request (e.g., to a server compute device 140, 142) for a unique identifier to initiate and track the progress of the check in operation. For example, the mobile compute device 130 may send the request in response to the guest initiating a software application on the mobile compute device 130 to check in to a hotel room. In some embodiments, the unique identifier may be embedded in a uniform resource locator (URL) transmitted to the mobile compute device 130 (via SMS text message) and the guest may verify his or her intent to proceed with the check in operation by selecting the URL (also referred to as a “link”).

In response to detecting the guest's selection of the URL (e.g., in the received text message), the mobile compute device 130 may transmit, to a server compute device (e.g., the server compute device 140) a request (e.g., a verification of the request) to perform a check in operation based on a the URL received by the mobile compute device, as indicated in block 316. By transmitting the request, based on the URL containing the unique identifier, the server compute device 140 may confirm that the check in operation associated with the unique identifier should proceed (e.g., that the guest is using the mobile compute device 130 to perform the check in operation and intends to proceed with the check in operation). The mobile compute device 130 may also store a cookie (e.g., provided by the server compute device 140) that is usable by the server compute device 140 to associate that particular check in operation with the mobile compute device 130 and to track the progress of the check in operation. Additionally or alternatively, the server compute device 140 may store an address of the mobile compute device 130 (e.g., an internet protocol address, etc.) to associate the check in operation with that mobile compute device 130.

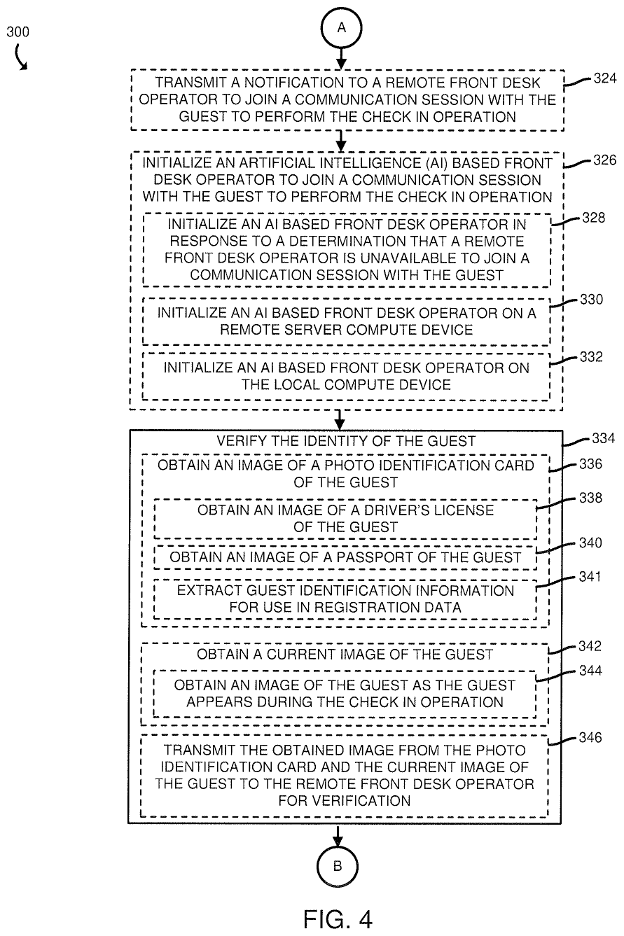

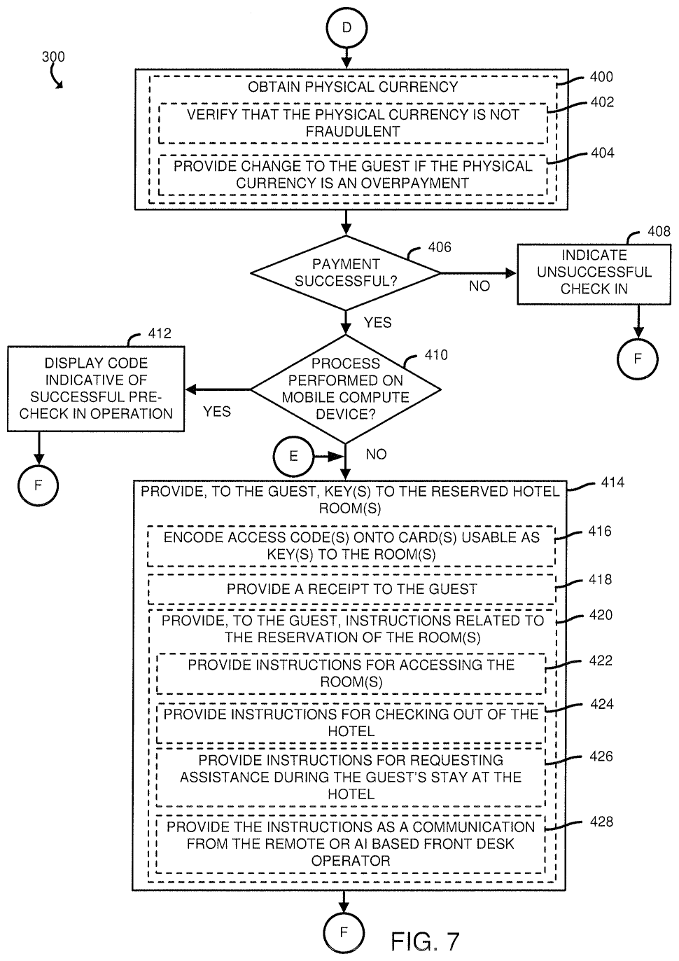

As indicated in block 318, in embodiments in which the kiosk compute device 120 performs the method 300, the kiosk compute device 120 may obtain a visual code indicative of a completed pre-check in operation, as indicated in block 318. That is, in some embodiments, the mobile compute device 130, upon completing a majority of the steps in a check in operation (e.g., except for receiving a key to the room) may display a visual code to be shown to a kiosk compute device (e.g., the kiosk compute device 120) by the guest. The kiosk compute device 120, in the illustrative embodiment, may obtain the visual code using an image capture device 224 (e.g., a digital camera). As indicated in block 320, the kiosk compute device 120 may obtain an image of a barcode (e.g., a one dimensional barcode, a two dimensional barcode (e.g., a quick response (QR) code)) indicative of a completed check in operation. The visual code may include (e.g., have encoded therein) the unique identifier (e.g., from block 308), usable by the kiosk compute device 120 to retrieve details (e.g., the guest's identity, confirmation that payment was obtained for a particular room or rooms of the hotel, etc.) about the check in operation (e.g., from a server compute device 140, 142). In block 322, the method 300 may proceed along one of multiple different paths depending on whether a pre-check in code was obtained (e.g., from block 318). If so, the method 300 advances to block 414 of FIG. 7, in which the kiosk compute device 120 provides one or more keys to the guests for one or more reserved rooms of the hotel (e.g., the hotel 110 in which the kiosk compute device 120 is located). Otherwise, the method 300 advances to block 324 of FIG. 4, in which the kiosk compute device 120 may transmit a notification to a remote front desk operator (e.g. to a front desk operator compute device 160, 162) to join a communication session (e.g., a video session) with the guest to perform the check in operation.

Referring now to FIG. 4, the kiosk compute device 120 may, in some embodiments, initialize an artificial intelligence (AI) based front desk operator to join a communication session with the guest to perform the check in operation, as indicated in block 326. For example, the kiosk compute device 120 may initialize a set of algorithms to display an avatar representing a front desk operator, to interpret spoken words (e.g., from the guest), to interpret visual information (e.g., nodding of the guest's head, shaking of the guest's head, etc.), to produce audio in the form of speech (e.g., in the guest's spoken language), to synchronize movements of the avatar's face and body with the speech, and/or perform other functions to simulate the experience of communicating with a human front desk operator. The algorithms may include machine learning algorithms, one or more neural networks, natural language processing algorithms, object recognition algorithms, etc. and, in the illustrative embodiment, may rely on the image capture device 224 and the audio capture device 228 of the kiosk compute device 120 to obtain input visual and audio data (e.g., images/video frames of the guest, spoken words of the guest, etc.), and may rely on the display device 230 and an audio output device (e.g., a speaker) of the kiosk compute device 120 to provide an output of the AI based front desk operator to the guest.

As indicated in block 328, the kiosk compute device 120 may initialize the AI based front desk operator in response to a determination that a remote front desk operator is unavailable to join a communication session with the guest. For example, the kiosk compute device 120 may initially transmit the notification in block 324 and in response to a timeout (e.g., a predefined amount of time elapsing without a response from a front desk operator compute device 160, 162), the kiosk compute device 120 may initialize the AI based front desk operator as a fallback. In some embodiments, the kiosk compute device 120 may initialize the AI based front desk operator on a remote server compute device 140, 142 (e.g., the kiosk compute device 120 may send a request to the remote server compute device 140, 142 that causes an AI based front desk operator to be initialized), as indicated in block 330. In some embodiments, the kiosk compute device 120 may alternatively initialize the AI based front desk operator on a front desk operator compute device 160, 162 (e.g., in embodiments in which a front desk operator compute device 160, 162 is configured to execute an AI based front desk operator when a human front desk operator is unavailable to communicate with the guest from the front desk operator compute device 160, 162). The kiosk compute device 120, in some embodiments, may locally initialize the AI based front desk operator (e.g., execute the algorithms associated with instantiating the AI based front desk operator using the components (e.g., compute engine 210, etc.) of the kiosk compute device 120), as indicated in block 332.

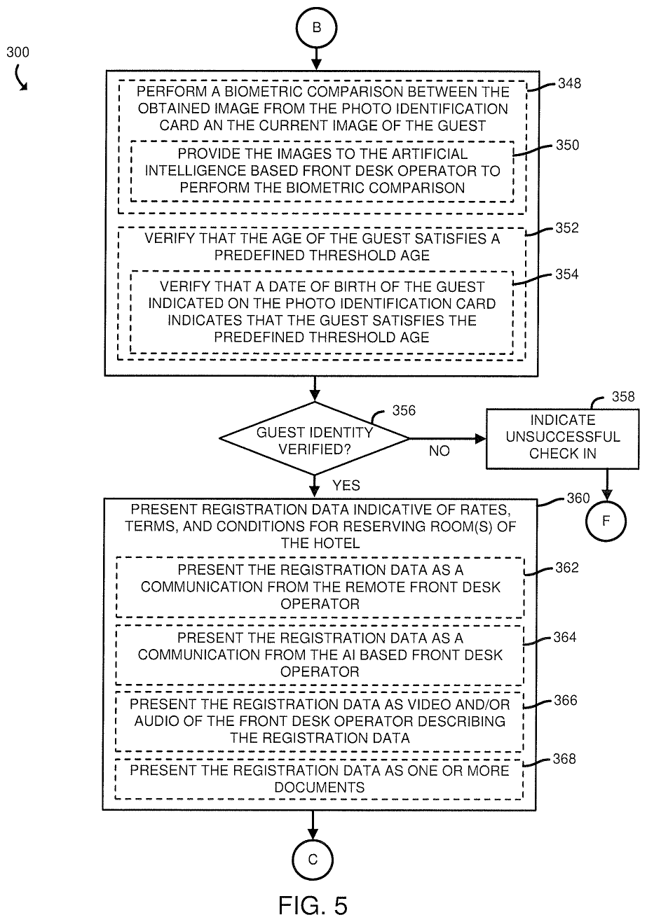

In block 334, the kiosk compute device 120 verifies the identity of the guest. In doing so, and as indicated in block 336, the kiosk compute device 120 may obtain an image of a photo identification card of the guest. For example, the kiosk compute device 120 may prompt the guest to hold up the guest's photo identification card to a camera (e.g., image capture device 224) of the kiosk compute device 120 and the kiosk compute device 120 may capture an image of the photo identification card using the camera (e.g., image capture device 224). As indicated in blocks 338 and 340, the kiosk compute device 120 may obtain an image of a driver's license or a passport of the guest. As indicated in block 341, the kiosk compute device 120 may extract (e.g., using optical character recognition) guest identification information (e.g., the guest's name, the guest's address, etc.) present on the photo identification card, for use in preparing registration data (e.g., one or more documents indicating rates, terms, and conditions and representing an agreement between the guest and the organization operating the hotel). That is, the kiosk compute device 120 may incorporate the extracted guest identification data into the registration data (e.g., by prepopulating fields in the registration data for the guest's name, address, and/or other identification information) or provide the extracted guest identification data to another compute device of the system 100 (e.g., a server compute device 140, 142, a front desk operator compute device 160, 162, etc.) to incorporate the extracted identification information into the registration data. The registration data is described in more detail with reference to block 360 of FIG. 5.

In other embodiments, the kiosk compute device 120 may obtain an image of another type of photo identification card or document depicting the guest and displaying identifying information associated with the guest (e.g., the guest's name, address, etc.). Further, the kiosk compute device 120, in the illustrative embodiment, obtains a current image of the guest, as indicated in block 342. In doing so, and as indicated in block 344, the kiosk compute device 120 obtains an image of the guest as the guest appears during the check in operation (e.g., the kiosk compute device 120 obtains a “selfie” of the guest using the image capture device 224). The kiosk compute device 120, in block 346, may transmit an obtained image of the guest from the photo identification card (e.g., from block 336) and the current image of the guest (e.g., from block 342) to the remote front desk operator (e.g., to the front desk operator compute device 160, 162 associated with the communication session initiated in block 324) for verification of the guest's identity (e.g., that the images depict the same person).

Referring now to FIG. 5, in verifying the identity of the guest, the kiosk compute device 120 may perform a biometric comparison (e.g., comparison of shapes, sizes, locations, and colors of facial features) between the obtained image from the photo identification card (e.g., from block 336) and the current image of the guest (from block 342), as indicated in block 348. In some embodiments, the kiosk compute device 120 may provide the images to the AI based front desk operator (e.g., initialized in block 326 of FIG. 4) to perform the biometric comparison, as indicated in block 350. The kiosk compute device 120 may also verify that the age of the guest satisfies predefined threshold age (e.g., a minimum age to check in to the hotel) as indicated in block 352. In doing so, the kiosk compute device 120 may verify that the date of birth of the guest, indicated on the photo identification card, indicates that the guest satisfies the predefined threshold age (e.g., by subtracting the date of birth from the present date and determining whether the resulting value is greater than or equal to the threshold age), as indicated in block 354. In block 356, the kiosk compute device 120 determines the subsequent course of action based on whether the guest's identity has been verified. If the guest's identity is not verified, the method 300 advances to block 358 in which the kiosk compute device 120 indicates an unsuccessful check in operation, such as by displaying, with the display device 230, a message indicating that an unsuccessful check in operation occurred (e.g., due to a failure to verify the guest's identity, age, etc.). Subsequently, the method 300 may loop back to block 304 of FIG. 3 in which the kiosk compute device 120 may receive another request to perform a check in operation (e.g., from another guest). Otherwise (e.g., if the identity verification is successful), the method 300 advances to block 360 in which the kiosk compute device 120 presents registration data indicative of rates, terms, and conditions for reserving one or more rooms of the hotel (e.g., the hotel 110).

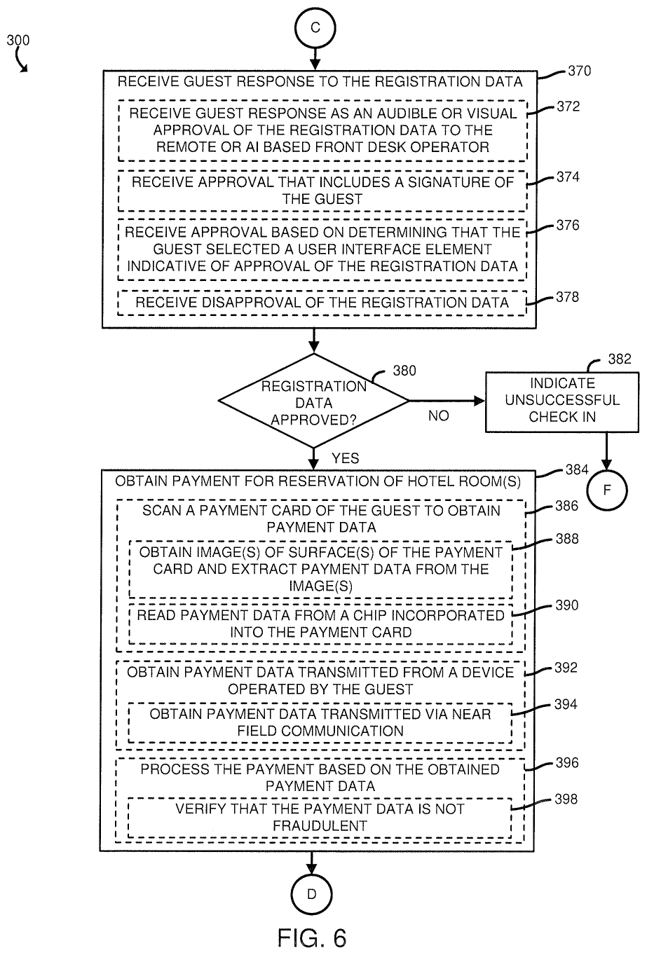

In presenting the registration data, the kiosk compute device 120 may present the registration data as a communication from the remote front desk operator (e.g., a human front desk operator with whom a communication session was initiated in block 324 of FIG. 4), as indicated in block 362. As indicated in block 364, the kiosk compute device 120 may present the registration data as a communication from the AI based front desk operator (e.g., the AI based front desk operator initiated in block 326 of FIG. 4). In some embodiments, the kiosk compute device 120 may present the registration data as video and/or audio of the front desk operator (e.g., the remote front desk operator at one of the front desk operator compute devices 160, 162 or the AI based front desk operator) describing the registration data, as indicated in block 366. Additionally or alternatively, the kiosk compute device 120 may present the registration data as one or more documents (e.g., displayed by the display device 230) for the guest to review, as indicated in block 368. Subsequently, the method 300 advances to block 370 of FIG. 6, in which the kiosk compute device 120 receives the guest's response to the registration data.

Referring now to FIG. 6, in receiving the guest's response to the registration data, the kiosk compute device 120 may receive the guest's response as an audible or visual approval (e.g., a spoken “yes” and/or nod of the guest's head) of the registration data, which the kiosk compute device 120 may capture with the image capture device 224 and/or the audio capture device 228 and direct (e.g., transmit, communicate, etc.) to the front desk operator (e.g., a front desk operator located at the corresponding front desk operator compute device 160, 162, or an AI based front desk operator), as indicated in block 372. As indicated in block 374, the kiosk compute device 120 may receive an approval (i.e., of the registration data) that includes a signature of the guest (e.g., by receiving a signature input by the guest on the display device 230, which may be embodied as a touchscreen). Additionally or alternatively, the kiosk compute device 120 may receive approval based on determining that the guest selected a user interface element indicative of approval of the registration data (e.g., by detecting that the guest touched an “Agree” button displayed on the display device 230, which may be embodied as a touchscreen), as indicated in block 376. In some embodiments, the kiosk compute device 120 may receive disapproval of the registration data, such as by detecting that the user spoke the word “No”, pressed a “Disagree” button, or otherwise indicated disapproval of the rates, terms, and conditions, as indicated in block 378. In block 380, the kiosk compute device 120 determines the subsequent course of action as a function of whether the registration data was approved by the guest. If the kiosk compute device 120 determines that the guest did not approve the registration data, the method 300 proceeds to block 382, in which the kiosk compute device 120 indicates an unsuccessful check in operation (e.g., by displaying a message that check in was not completed, etc.) and loops back to block 304 to await another request to perform a check in operation. Otherwise, if the guest did approve the registration data, the method 300 advances to block 384, in which the kiosk compute device 120 obtains payment for reservation of the hotel room(s) for the guest.

In obtaining payment, the kiosk compute device 120 may scan a payment card (e.g., a credit card, a debit card, etc.) of the guest to obtain payment data, as indicated in block 386. In doing so, and as indicated in block 388, the kiosk compute device 120 may obtain one or more images of one or more surfaces of the payment card and extract payment data from the images. For example, the kiosk compute device 120 may utilize the image capture device 224 to obtain an image of the front of the payment card to extract the payment card number and expiration data, and obtain an image of the back of the payment card to extract a security code printed thereon. Alternatively, the kiosk compute device 120 may read (e.g., with the money management device 232) payment data from an integrated circuit chip incorporated into the payment card (i.e., an EMV card or smart card), as indicated in block 390. In other embodiments, the kiosk compute device 120 may read the payment data from a magnetic strip on the payment card or from another machine-readable medium incorporated into the payment card. As indicated in block 392, the kiosk compute device 120 may obtain payment data transmitted from a device operated by the guest. As indicated in block 394, the kiosk compute device 120 may obtain payment data transmitted by the device operated by the guest via near field communication (NFC) or another short range wireless protocol (e.g., transmitted wirelessly by the mobile compute device 130 of the guest through Apple Pay or Google Pay). In block 396, the kiosk compute device 120 processes the payment based on the obtained payment data (e.g., by submitting the payment data through a corresponding payment processing network, such as the MasterCard payment processing network, the Visa payment processing network, etc.). In doing so, the kiosk compute device 120 obtains verification that the payment data is not fraudulent (e.g., by receiving data indicative of whether the payment was successful from the corresponding payment processing network or receiving a failure code, which may indicate that the payment data was fraudulent), as indicated in block 398.

Referring now to FIG. 7, in some embodiments, the kiosk compute device 120 may obtain physical currency (e.g., dollars, coins, etc.) as payment for the reservation of the room(s), as indicated in block 400. In such embodiments, the kiosk compute device 120 may receive the physical currency using the money management device 232 described with reference to FIG. 2. In doing so, and as indicated in block 402, the kiosk compute device 120 may verify that the physical currency is not fraudulent, such as by analyzing the currency to determine whether security features (an embedded strip that becomes visible when exposed to a light, predefined watermark(s), etc.) are present in the currency. If the guest overpaid, the kiosk compute device 120 provides change to the guest, as indicated in block 404. In block 406, the kiosk compute device 120 determines the subsequent course of action based on whether the payment was successful. If the payment was not successful (e.g., the payment data or physical currency was fraudulent, there were insufficient funds, etc.), the method 300 advances to block 408 in which the kiosk compute device 120 indicates (e.g., visually, audibly, etc.) to the guest that the check in operation was unsuccessful (e.g., due to an unsuccessful payment). Subsequently, the method 300 loops back to block 304 of FIG. 3, in which the kiosk compute device 120 awaits another request to perform a check in operation. Otherwise (e.g., if the payment was successful), the method 300 proceeds to block 410 in which a determination is made based on whether the method 300 thus far has been performed by a kiosk compute device (e.g., the kiosk compute device 120) or a mobile compute device (e.g., the mobile compute device 130).

As stated above, while the method 300 is described herein as being performed by the kiosk compute device 120 for simplicity, the majority of the operations of the method 300 may be performed by a mobile compute device (e.g., the mobile compute device 130) except as indicated otherwise in the description. If the method 300 has been performed by a mobile compute device 130 (rather than a kiosk compute device 120), the method 300 advances to block 412 in which the mobile compute device (e.g., the mobile compute device 130) displays a code indicative of a successful pre-check in operation. The code, in the illustrative embodiment is a visual code, such as a bar code (e.g., a one dimensional bar code or a two dimensional bar code, such as a QR code). The code may be received by the mobile compute device 130 from another compute device (e.g., a server compute device 140, 142 or front desk operator compute device 160, 162) through the network 180 or generated locally (e.g., by the mobile compute device 130 itself). The method 300 subsequently loops back to block 304, wherein a kiosk compute device (e.g., the kiosk compute device 120) may scan the code displayed by the mobile compute device 130 (e.g., in sub block 318).

If the method 300 is being performed by a kiosk compute device (e.g., the kiosk compute device 120) and the payment for the hotel room(s) was successful, the method 300 advances to block 414 in which the kiosk compute device 120 provides, to the guest, key(s) to the reserved room(s) of the hotel (e.g., the hotel 110). In doing so, and as indicated in block 416, the kiosk compute device 120 may encode access code(s) onto card(s) that are usable as key(s) to the reserved room(s) (e.g., using the key management device 226). In other embodiments, the kiosk compute device 120 may dispense another type of key (e.g., a metal key that is insertable into a door lock to mechanically unlock the door, a fob, etc.). In block 418, the kiosk compute device 120 may provide a receipt to the guest. The kiosk compute device 120 may also provide, to the guest, instructions related to the reservation of the room(s), as indicated in block 420. For example, and as indicated in block 422, the kiosk compute device 120 may provide instructions for accessing the room(s) (e.g., providing directions to the room, instructions for operating the key(s), etc.).

As indicated in block 424, the kiosk compute device 120 may provide instructions for checking out of the hotel (e.g., the hotel 110), such as providing a time when the guest is expect to check out, instructions on how to return or dispose of the key(s), etc. The kiosk compute device 120 may also provide instructions for requesting assistance during the guest's stay at the hotel (e.g., the hotel 110), as indicated in block 426. For example, the kiosk compute device 120 may provide a phone number to call for room service. In providing the instructions, the kiosk compute device 120 may provide the instructions as a communication from a remote front desk operator (e.g., as video/audio communication from a person operating a front desk operator compute device 160, 162) or from an AI based front desk operator (e.g., as an avatar speaking the instructions), as indicated in block 428. In other embodiments, the kiosk compute device 120 may provide the instructions in another manner (e.g., by displaying text and/or graphics indicating the instructions). Afterwards, the method 300 loops back to block 304 of FIG. 3 in which the kiosk compute device 120 awaits another request to perform a check in operation.

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. Further, it should be understood that while the methods and systems are described above in connection with reservation of rooms in a hotel, it is contemplated that the systems and methods may be used for efficiently checking in to other facilities or locations (e.g., hospitals, resorts, etc.). There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a compute device comprising circuitry configured to receive a request to check in a guest at a hotel without a human front desk operator present at the hotel; verify an identity of the guest; obtain payment, from the guest, for reservation of a room of the hotel; and provide, to the guest and in response to obtaining payment for reservation of the room, a key to the room of the hotel.

Example 2 includes the subject matter of Example 1, and wherein the circuitry is further to transmit, in response to receiving the request to check in a guest at a hotel without a human front desk operator present, a notification to a remote front desk operator to join a communication session with the guest to perform a check in operation.

Example 3 includes the subject matter of any of Examples 1 and 2, and wherein the circuitry is further to initialize an artificial intelligence based front desk operator to join a communication session with the guest to perform a check in operation.

Example 4 includes the subject matter of any of Examples 1-3, and wherein the circuitry is further to present, to the guest, registration data indicative of rates, terms, and conditions for reserving a room at the hotel; and receive a response from the guest indicative of approval of the registration data; and wherein to provide, to the guest, a key to the room of the hotel comprises to provide the key to the room to the hotel further in response to receiving approval of the registration data.

Example 5 includes the subject matter of any of Examples 1-4, and wherein to present the registration data comprises to present the registration data as a communication from a remote front desk operator in a communication session with the guest.

Example 6 includes the subject matter of any of Examples 1-5, and wherein to verify an identity of the guest comprises to obtain an image of a photo identification card of the guest; obtain a current image of the guest as the guest appears during the check in operation; and transmit the obtained image from the photo identification card and the current image of the guest to a remote front desk operator for verification that the images both represent the guest.

Example 7 includes the subject matter of any of Examples 1-6, and wherein to verify an identity of the guest comprises to obtain an image of a photo identification card of the guest; obtain a current image of the guest as the guest appears during the check in operation; and provide the images to an artificial intelligence based front desk operator to perform a biometric comparison between the images to verify the identity of the guest.

Example 8 includes the subject matter of any of Examples 1-7, and wherein to obtain payment for reservation of a room of the hotel comprises to scan a payment card of the guest to obtain payment data; and process the payment based on the obtained payment data.

Example 9 includes the subject matter of any of Examples 1-8, and wherein to scan a payment card comprises to scan an image of a surface of the payment card to obtain the payment data.

Example 10 includes the subject matter of any of Examples 1-9, and wherein to obtain payment for reservation of a room of the hotel comprises to obtain physical currency from the guest.

Example 11 includes the subject matter of any of Examples 1-10, and wherein to provide a key to the room of the hotel comprises to encode an access code on a card that is usable as a key to access the room of the hotel.

Example 12 includes the subject matter of any of Examples 1-11, and wherein the compute device is a kiosk compute device located in the hotel.

Example 13 includes the subject matter of any of Examples 1-12, and wherein the compute device is further to receive an image of a code indicative of a completed pre-check in operation performed on a mobile compute device of a second guest; and provide, to the second guest and in response receiving the image of the code, a key to a hotel room associated with the completed pre-check in operation.

Example 14 includes a method comprising receiving, by a compute device, a request to check in a guest at a hotel without a human front desk operator present at the hotel; verifying, by the compute device, an identity of the guest; obtaining, by the compute device, payment, from the guest, for reservation of a room of the hotel; and providing, by the compute device, to the guest and in response to obtaining payment for reservation of the room, a key to the room of the hotel.

Example 15 includes the subject matter of Example 14, and further including transmitting, by the compute device and in response to receiving the request to check in a guest at a hotel without a human front desk operator present, a notification to a remote front desk operator to join a communication session with the guest to perform a check in operation.

Example 16 includes the subject matter of any of Examples 14 and 15, and further including initializing, by the compute device, an artificial intelligence based front desk operator to join a communication session with the guest to perform a check in operation.

Example 17 includes the subject matter of any of Examples 14-16, and further including presenting, by the compute device and to the guest, registration data indicative of rates, terms, and conditions for reserving a room at the hotel; and receiving, by the compute device, a response from the guest indicative of approval of the registration data; and wherein providing, to the guest, a key to the room of the hotel comprises providing the key to the room to the hotel further in response to receiving approval of the registration data.

Example 18 includes the subject matter of any of Examples 14-17, and wherein presenting the registration data comprises presenting the registration data as a communication from a remote front desk operator in a communication session with the guest.

Example 19 includes the subject matter of any of Examples 14-18, and wherein verifying an identity of the guest comprises obtaining, by the compute device, an image of a photo identification card of the guest; obtaining, by the compute device, a current image of the guest as the guest appears during the check in operation; and transmitting, by the compute device, the obtained image from the photo identification card and the current image of the guest to a remote front desk operator for verification that the images both represent the guest.

Example 20 includes the subject matter of any of Examples 14-19, and wherein verifying an identity of the guest comprises obtaining an image of a photo identification card of the guest; obtaining a current image of the guest as the guest appears during the check in operation; and providing the images to an artificial intelligence based front desk operator to perform a biometric comparison between the images to verify the identity of the guest.

Example 21 includes the subject matter of any of Examples 14-20, and wherein obtaining payment for reservation of a room of the hotel comprises scanning a payment card of the guest to obtain payment data; and processing the payment based on the obtained payment data.

Example 22 includes the subject matter of any of Examples 14-21, and wherein scanning a payment card comprises scanning an image of a surface of the payment card to obtain the payment data.

Example 23 includes the subject matter of any of Examples 14-22, and wherein obtaining payment for reservation of a room of the hotel comprises obtaining, by the compute device, physical currency from the guest.

Example 24 includes the subject matter of any of Examples 14-23, and wherein providing a key to the room of the hotel comprises encoding an access code on a card that is usable as a key to access the room of the hotel.

Example 25 includes the subject matter of any of Examples 14-24, and wherein the compute device is a kiosk compute device located in the hotel, the method further comprising receiving, by the compute device, an image of a code indicative of a completed pre-check in operation performed on a mobile compute device of a second guest; and providing, by the compute device and to the second guest and in response receiving the image of the code, a key to a hotel room associated with the completed pre-check in operation.

Example 26 includes one or more machine-readable storage media comprising a plurality of instructions stored thereon that, in response to being executed, cause a compute device to receive a request to check in a guest at a hotel without a human front desk operator present at the hotel; verify an identity of the guest; obtain payment, from the guest, for reservation of a room of the hotel; and provide, to the guest and in response to obtaining payment for reservation of the room, a key to the room of the hotel.

Example 27 includes the subject matter of Example 26, and wherein the instructions further cause the compute device to transmit, in response to receiving the request to check in a guest at a hotel without a human front desk operator present, a notification to a remote front desk operator to join a communication session with the guest to perform a check in operation.

Example 28 includes the subject matter of any of Examples 26 and 27, and wherein the instructions further cause the compute device to initialize an artificial intelligence based front desk operator to join a communication session with the guest to perform a check in operation.

Example 29 includes the subject matter of any of Examples 26-28, and wherein the instructions further cause the compute device to present, to the guest, registration data indicative of rates, terms, and conditions for reserving a room at the hotel; and receive a response from the guest indicative of approval of the registration data; and wherein to provide, to the guest, a key to the room of the hotel comprises to provide the key to the room to the hotel further in response to receiving approval of the registration data.

Example 30 includes the subject matter of any of Examples 26-29, and wherein to present the registration data comprises to present the registration data as a communication from a remote front desk operator in a communication session with the guest.

Example 31 includes the subject matter of any of Examples 26-30, and wherein to verify an identity of the guest comprises to obtain an image of a photo identification card of the guest; obtain a current image of the guest as the guest appears during the check in operation; and transmit the obtained image from the photo identification card and the current image of the guest to a remote front desk operator for verification that the images both represent the guest.

Example 32 includes the subject matter of any of Examples 26-31, and wherein to verify an identity of the guest comprises to obtain an image of a photo identification card of the guest; obtain a current image of the guest as the guest appears during the check in operation; and provide the images to an artificial intelligence based front desk operator to perform a biometric comparison between the images to verify the identity of the guest.

Example 33 includes the subject matter of any of Examples 26-32, and wherein to obtain payment for reservation of a room of the hotel comprises to scan a payment card of the guest to obtain payment data; and process the payment based on the obtained payment data.

Example 34 includes the subject matter of any of Examples 26-33, and wherein to scan a payment card comprises to scan an image of a surface of the payment card to obtain the payment data.

Example 35 includes the subject matter of any of Examples 26-34, and wherein to obtain payment for reservation of a room of the hotel comprises to obtain physical currency from the guest.

Example 36 includes the subject matter of any of Examples 26-35, and wherein to provide a key to the room of the hotel comprises to encode an access code on a card that is usable as a key to access the room of the hotel.

Example 37 includes the subject matter of any of Examples 26-36, and wherein the compute device is a kiosk compute device located in the hotel and the instructions further cause the compute device to receive an image of a code indicative of a completed pre-check in operation performed on a mobile compute device of a second guest; and provide, to the second guest and in response receiving the image of the code, a key to a hotel room associated with the completed pre-check in operation.

Example 38 includes a mobile compute device comprising circuitry to receive a request to check in a guest at a hotel without a human front desk operator present at the hotel; initiate a communication session with a front desk operator that is either (i) a human operating a remote compute device or (ii) an artificial intelligence; verify, through communication with the front desk operator, an identity of the guest based on an obtained image of a photo identification card of the guest and a current image of the guest; obtain, through communication with the front desk operator, payment from the guest for reservation of a room of the hotel; and receive a visual code indicative of a complete pre-check in operation to be presented to a kiosk compute device in a hotel to obtain a key to a corresponding room of the hotel.

Example 39 includes a method comprising receiving, by a mobile compute device, a request to check in a guest at a hotel without a human front desk operator present at the hotel; initiating, by the mobile compute device, a communication session with a front desk operator that is either (i) a human operating a remote compute device or (ii) an artificial intelligence; verifying, by the mobile compute device and through communication with the front desk operator, an identity of the guest based on an obtained image of a photo identification card of the guest and a current image of the guest; obtaining, by the mobile compute device and through communication with the front desk operator, payment from the guest for reservation of a room of the hotel; and receiving, by the mobile compute device, a visual code indicative of a complete pre-check in operation to be presented to a kiosk compute device in a hotel to obtain a key to a corresponding room of the hotel.

Example 40 includes one or more machine-readable storage media comprising a plurality of instructions stored thereon that, in response to being executed, cause a mobile compute device to receive a request to check in a guest at a hotel without a human front desk operator present at the hotel; initiate a communication session with a front desk operator that is either (i) a human operating a remote compute device or (ii) an artificial intelligence; verify, through communication with the front desk operator, an identity of the guest based on an obtained image of a photo identification card of the guest and a current image of the guest; obtain, through communication with the front desk operator, payment from the guest for reservation of a room of the hotel; and receive a visual code indicative of a complete pre-check in operation to be presented to a kiosk compute device in a hotel to obtain a key to a corresponding room of the hotel.

1. A compute device comprising:
circuitry configured to:
receive a request to check in a guest at a hotel without a human front desk operator present at the hotel;
verify an identity of the guest;
obtain payment, from the guest, for reservation of a room of the hotel; and
provide, to the guest and in response to obtaining payment for reservation of the room, a key to the room of the hotel.

2. The compute device of claim 1, wherein the circuitry is further to transmit, in response to receiving the request to check in a guest at a hotel without a human front desk operator present, a notification to a remote front desk operator to join a communication session with the guest to perform a check in operation.

3. The compute device of claim 1, wherein the circuitry is further to initialize an artificial intelligence based front desk operator to join a communication session with the guest to perform a check in operation.

4. The compute device of claim 1, wherein the circuitry is further to:
present, to the guest, registration data indicative of rates, terms, and conditions for reserving a room at the hotel; and
receive a response from the guest indicative of approval of the registration data; and
wherein to provide, to the guest, a key to the room of the hotel comprises to provide the key to the room to the hotel further in response to receiving approval of the registration data.

5. The compute device of claim 4, wherein to present the registration data comprises to present the registration data as a communication from a remote front desk operator in a communication session with the guest.

6. The compute device of claim 1, wherein to verify an identity of the guest comprises to:
obtain an image of a photo identification card of the guest;
obtain a current image of the guest as the guest appears during the check in operation; and
transmit the obtained image from the photo identification card and the current image of the guest to a remote front desk operator for verification that the images both represent the guest.

7. The compute device of claim 1, wherein to verify an identity of the guest comprises to:
obtain an image of a photo identification card of the guest;
obtain a current image of the guest as the guest appears during the check in operation; and
provide the images to an artificial intelligence based front desk operator to perform a biometric comparison between the images to verify the identity of the guest.

8. The compute device of claim 1, wherein to obtain payment for reservation of a room of the hotel comprises to:
scan a payment card of the guest to obtain payment data; and
process the payment based on the obtained payment data.

9. The compute device of claim 8, wherein to scan a payment card comprises to scan an image of a surface of the payment card to obtain the payment data.

10. The compute device of claim 1, wherein to obtain payment for reservation of a room of the hotel comprises to obtain physical currency from the guest.

11. The compute device of claim 1, wherein to provide a key to the room of the hotel comprises to encode an access code on a card that is usable as a key to access the room of the hotel.

12. The compute device of claim 1, wherein the compute device is a kiosk compute device located in the hotel.

13. The compute device of claim 12, wherein the compute device is further to:
receive an image of a code indicative of a completed pre-check in operation performed on a mobile compute device of a second guest; and
provide, to the second guest and in response receiving the image of the code, a key to a hotel room associated with the completed pre-check in operation.

14. A method comprising:
receiving, by a compute device, a request to check in a guest at a hotel without a human front desk operator present at the hotel;
verifying, by the compute device, an identity of the guest;
obtaining, by the compute device, payment, from the guest, for reservation of a room of the hotel; and
providing, by the compute device, to the guest and in response to obtaining payment for reservation of the room, a key to the room of the hotel.

15. The method of claim 14, further comprising transmitting, by the compute device and in response to receiving the request to check in a guest at a hotel without a human front desk operator present, a notification to a remote front desk operator to join a communication session with the guest to perform a check in operation.

16. The method of claim 14, further comprising initializing, by the compute device, an artificial intelligence based front desk operator to join a communication session with the guest to perform a check in operation.

17. The method of claim 14, further comprising:
presenting, by the compute device and to the guest, registration data indicative of rates, terms, and conditions for reserving a room at the hotel; and
receiving, by the compute device, a response from the guest indicative of approval of the registration data; and
wherein providing, to the guest, a key to the room of the hotel comprises providing the key to the room to the hotel further in response to receiving approval of the registration data.

18. The method of claim 17, wherein presenting the registration data comprises presenting the registration data as a communication from a remote front desk operator in a communication session with the guest.

19. The method of claim 14, wherein verifying an identity of the guest comprises:
obtaining, by the compute device, an image of a photo identification card of the guest;
obtaining, by the compute device, a current image of the guest as the guest appears during the check in operation; and
transmitting, by the compute device, the obtained image from the photo identification card and the current image of the guest to a remote front desk operator for verification that the images both represent the guest.

20. A method comprising:
receiving, by a mobile compute device, a request to check in a guest at a hotel without a human front desk operator present at the hotel;
initiating, by the mobile compute device, a communication session with a front desk operator that is either (i) a human operating a remote compute device or (ii) an artificial intelligence;
verifying, by the mobile compute device and through communication with the front desk operator, an identity of the guest based on an obtained image of a photo identification card of the guest and a current image of the guest;
obtaining, by the mobile compute device and through communication with the front desk operator, payment from the guest for reservation of a room of the hotel; and
receiving, by the mobile compute device, a visual code indicative of a complete pre-check in operation to be presented to a kiosk compute device in a hotel to obtain a key to a corresponding room of the hotel.
